(19) United States
(12) Patent Application Publication
(10) Pub. No.: US 2014/0310264 A1
(43) Pub. Date: Oct. 16, 2014

(54) IMAGE REGISTRATION SYSTEM AND METHOD

(71) Applicant: Mark D'Ambrosio, Scottsdale, AZ (US)

(72) Inventor: Mark D'Ambrosio, Scottsdale, AZ (US)

(21) Appl. No.: 14/253,683

(22) Filed: Apr. 15, 2014

Related U.S. Application Data
(60) Provisional application No. 61/812,144, filed on Apr. 15, 2013.

(51) Int. Cl. G06F 17/30

(52) U.S. Cl. CPC G06F 17/30265
USPC 707/722

(57) ABSTRACT

A system and method of managing an image registry may include receiving an image and metadata associated with the image to be associated with the user, where the user may be an author of the image stored in the image registry. A registration timestamp in response to receiving the image may be generated. The image, metadata, and registration timestamp may be stored in relation to the user. An identity of the author of the image may be caused to be displayed for the user in response to receiving a query to identify the author of the image, where the query may be inclusive of at least a portion of the metadata or image.

### RELATED APPLICATIONS

This Application claims priority to co-pending U.S. Provisional Application Ser. No. 61/812,144 entitled “Image Registration System and Method” filed on Apr. 15, 2013; the contents of which are hereby incorporated by reference in their entirety.

### BACKGROUND

With the creation and widespread adoption of digital photography, especially through the integration with mobile devices, such as mobile telephones, millions of people have become more versed and comfortable with digital image creation, including photographs and video (“images”). With people creating and posting or otherwise uploading those images onto public networks, such as the Internet, and applications, such as social networking sites, peer-to-peer applications, and so forth, the ability to track authorship and/or ownership of those images has become difficult or impossible.

Professional photographers, celebrities, or people who later become celebrities may create images that are or may become very valuable and commercially desirable. As well understood, an image that is used by another without permission of an author is a violation of copyright law. Such violations are quite common on the Internet for a variety of reasons. However, it is often difficult to prove authorship and ownership of such images. As an example, in the event of a mobile telephone becoming hacked or online image becoming used without an author's permission, a publisher who publishes images without permission of an owner of the copyright often relies on proof of authorship and ownership being difficult to achieve by an author, thus making it difficult for an author and/or owner to enforce his or her copyright rights against the publisher.

### SUMMARY

In order to provide protection to authors and/or owners of digital images, the principles of the present invention provide for an online registry by which digital images, such as photographs and videos, may be communicated or uploaded, applied a unique identifier, timestamped, and stored by the online registry so as to support authors and/or owners as to rights to the images. By providing provable rights, issues, such as unauthorized usage of the images, copyright infringement, privacy rights, and so forth, may be more easily addressed by authors and/or owners of the images. The registry may also provide for seamless filing of the images in a copyright office (e.g., U.S. Copyright Office) for users to obtain copyright registration for the images.

The online registry may operate in a variety of ways, including storing the images, providing a user interface to upload and manage the images, searching for unauthorized copies of the images in the registry and online, and so on. In one embodiment, two timestamps, (i) a timestamp representative of the date and time of creation (e.g., date and time a digital camera created the image) and (ii) a timestamp representative of the date and time of registering the image with the registry, may be associated with an image by the registry. Other timestamps are also contemplated, such as the date and time that an image is communicated from a mobile device, for example. Other records, such as an “image trail,” showing addresses or phone numbers to which images are communicated may also be recorded with the registry.

A unique identifier may be created in a variety of ways. For example, the unique identifier may be created by a mobile device independently from an online registry, by a user entering a unique ID (optionally being verified as being unique via the registry), using a phone number of a mobile device, creating a unique ID based on the phone number, mobile ID, or other unique identifier of the mobile device, or any other technique as understood in the art. Each image may receive a unique registration number in addition to the unique ID for the user.

Once registered, a user may establish for each created image to be registered (i) automatically, (ii) semi-automatically, (iii) or manually. That is, registration of images may be performed automatically after each image is created (e.g., after a photograph is taken, on a periodic basis (e.g., daily), in response to an event (e.g., being plugged into a power adapter), upon an image being modified (i.e., derivative work) or otherwise with or without notifying a user of registering each image. Semi-automatic registration may be performed by a user being requested or prompted by a mobile device, computing device, or registry, for example, to register one or more images. Manual registration may be performed by the user initiating the registration process by requesting to register all or a subset of new images since a last registration. Other registration processes may additionally or alternatively be utilized in accordance with the principles of the present invention.

The registry may enable a user to categorize images being requested to make it easier to locate the image at a later date. For example, content or images may be categorized by job, professional/personal, trip name, geographical location (e.g., city), subject matter, or any other category or manner. Such categorization may be performed using tags, folders, metadata, or otherwise by the registry or by a user establishing such category customization.

Because the registry operates to record images that may later be used to show ownership and/or authenticity, the registry may allow for a user to request that one or more images be recorded at a copyright office, such as the U.S. Copyright Office. The registry may be configured (i) to automatically populate copyright application filing forms, and (ii) to electronically submit the copyright application to a copyright office. If a user intends to file for copyright protection, a payment mechanism, in addition to a basic registration service in the form of a monthly or annual fee for a certain number of registrations and/or storage capacity, may be established between the user and registry that manages the registration service.

As further protection to a user, an image capture device, such as a mobile phone, may be configured to create a digital signature or identifier that may or may not be visible to a viewer of the image. If not visible, the digital signature may be included in metadata or otherwise associated with or integrated data representative of the image.

One embodiment of a method of managing an image registry may include receiving an image and metadata associated with the image to be associated with the user, where the user may be an author of the image stored in the image registry. A registration timestamp in response to receiving the image may be generated. The image, metadata, and registration timestamp may be stored in relation to the user. An identity of the author of the image may be caused to be displayed for the user in response to receiving a query to identify the author of the image, where the query may be inclusive of at least a portion of the metadata or image.

One embodiment of a system for managing an image registry may include a storage unit configured to store the image registry, and a processing unit in communication with the storage unit. The processing unit may be configured to receive an image and metadata associated with the image to be associated with the user, where the user may be an author of the image stored in the image registry. A registration timestamp may be generated in response to receiving the image. The image, metadata, and registration timestamp may be stored in relation to the user. An identity of the author of the image may be caused to be displayed for the user in response to receiving a query to identify the author of the image, where the query may be inclusive of at least a portion of the metadata or image.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an illustrative network environment in which users of mobile devices or other electronic devices with imaging collection or storage capabilities may utilize a digital image registry for registering digital images created by the respective users;

FIG. 2 is a block diagram of an illustrative mobile device configured to capture digital images, register the images with a digital image registry, and, optionally, apply a digital signature to the digital images;

FIG. 3 is a block diagram of illustrative software modules configured to capture digital images, register digital images, and apply a digital signature to the digital images;

FIG. 4 is a block diagram of an illustrative registry server configured to collect digital images from electronic devices of users, and store and manage the digital images that are registered in the registry;

FIG. 5 is a block diagram of illustrative software modules that may be executed by the registry server of FIG. 4 for enabling a registry to manage registered digital images;

FIG. 6 is an illustration of an illustrative electronic device that is displaying a digital image that has been registered with a registry;

FIG. 7 is a screen shot of an illustrative user interface that provides for display of a list of registered digital images;

FIG. 8 is a screen shot of an illustrative user interface in which a user may search for registered digital images;

FIG. 9 is a screen shot of an illustrative message communicated to a user in response to the registry identifying that rights of the user are suspected of being violated by another user using the registered digital image without permission;

FIG. 10 is a screen shot of an illustrative message communicated to a user suspected of violating rights of another user through unauthorized use of a registered digital image;

FIG. 11 is a flow chart of an illustrative process for registering authorship of an image in accordance with the principles of the present invention; and

FIG. 12 is a flow diagram of illustrative process for managing an image registry.

### DETAILED DESCRIPTION OF THE DRAWINGS

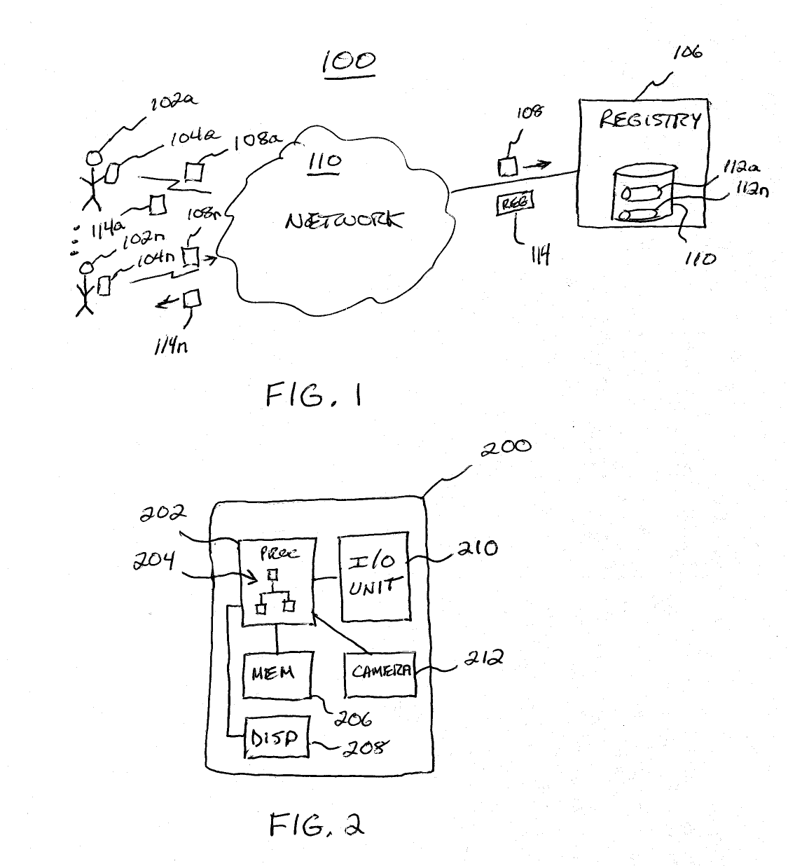

With regard to FIG. 1, an illustration of an illustrative network environment 100 in which users 102a-102n (collectively 102) of mobile devices 104a-104n (collectively 104) or other electronic devices with imaging collection and/or storage capabilities may utilize a digital image registry 106 for registering digital images, referred to hereafter as “images,” 108a-108n (collectively 108) created by the respective users 102. The respective users 102 are authors of the images 108. As understood in the art, an author is a person who creates a work, such as an image (e.g., photograph, video, drawing, audio, or any other content). An owner of the images 108 is either the author, employer of the author, or assignee of the images 108 through sale or other agreement. Thus, the author and owner may be different from one another. In either case, the ability to prove authorship and/or ownership of an image can be very difficult given the ease with which digital copies of an image or other work can be created and reused, repurposed, or otherwise.

The registry 106 may manage a data storage system 110 that is configured to store one or more data repositories 112a-112n (collectively 112). The data repositories 112 may store the images 108 in a variety of different storage techniques and configurations, such as relational databases, SQL databases, or NoSQL databases, as understood in the art. Each of the users 102 who use the registry 106 for registering their images, which may include photographs, videos, digital artwork, or any other digital work (raw or edited), as understood in the art, may have their originated works stored in relation to themselves and be device independent. In that regard, an identity of the author and/or owner of an image stored in the data repositories 112 may be associated with an author's account and the images 108 may be associated therewith such that the identity of the author and/or owner of the images 108 can later be identified. In one embodiment, the devices 104 may be configured with an app or embedded program integrated as part of the operating system of the device, that may be configured to communicate the images 108 with the registry. The app or embedded program may be configured to communicate the images automatically, semi-automatically, or manually, as further described herein.

The app or embedded program may further be configured to apply a unique digital signature associated with the respective users 102 to the respective images 108. In applying a unique digital signature, the users may set up the app or embedded program with information in which to create a digital signature. In one embodiment, the digital signature may be a unique signature that the user creates. In another embodiment, the digital signature may be a unique signature created by the app or embedded program being executed by the device of the user. Rather than using information associated with the user, the information may be unique information associated with the device, such as a mobile identifier. In yet another embodiment, the registry 106 may create digital signatures for each of the users 102 based on information associated with the respective users 102, respective devices 104, or independent of the users 102 or devices 104 (e.g., assigned identifier, such as a sequential number or identifier, randomly generated alphanumeric identifier created by the registry, or otherwise).

In response to the registry 106 receiving images 108, the registry 106 may communicate respective registration information 114a-114n (collectively 114) back to the respective devices 104a-104n that communicated the respective images 108a-108n to the registry 106. The registration information may include a registration identifier, such as an alphanumeric identifier (e.g., ABCD), an alphanumeric identifier that extends from a digital signature (e.g., ABCD-72BC34), counter that extends from the digital signature (e.g., ABCD-0714), or otherwise. In one embodiment, the registration information may include an identifier that causes an app or embedded program to include a registration indicia, such as “R,” in a particular color, style, or format, in association with the registered image. Other information, such as registration date and time, total number of images registered, amount of registration storage space used and/or available, date which the registered image is to be filed with a copyright office (if so requested by the user), and so forth. One embodiment may include associating a copyright office registration number with the image.

With regard to FIG. 2, a block diagram of an illustrative mobile device 200 configured to capture digital images, register the images with a digital image registry, and, optionally, apply a digital signature to the digital images, is shown. The mobile device 200 may include a processing unit configured to execute software 204. The software 204 may be an app or embedded software that is integrated into an operating system of the mobile device 200. The processing unit 202 may be in communication with memory 206, electronic display 208, input/output (I/O) unit 210, and camera 212. The I/O unit 210 may be configured to communicate images over one or more communication networks, such as a mobile telephone network, WiFi network, local area network (LAN), or any other communications network in any communications protocol, as understood in the art.

With regard to FIG. 3, a block diagram of illustrative software modules 300 configured to capture digital images, register digital images, and optionally apply a digital signature to the digital images, for example, is shown. The software modules 300 may include an image capture module 302 that is configured to communicate with an image sensor of a camera of the mobile device to receive images captured by the camera by a user. In capturing the images, the image capture module 302 may store the images in a memory of the device in a chronological or other manner, as understood in the art.

An image registry registration module 304 may enable a user to register with an image registry. In enabling the user to register, the module 304 may be configured to collect user data for communication to the registry. The module 304 may be configured to prompt the user of the device, such as a smart phone, to register with the registry in a first use of the image capture module 302. The module 304 may be configured to opt-in or opt-out of becoming a member of the registry.

An image registry preferences module 306 may be configured to establish preferences for registering images with the registry. For example, the preferences may include “register all images,” “automatically register images,” “prompt to register images,” “register after 10 images captured,” “only register images captured by this device,” and so forth. If all images captured by the device are to be automatically registered, then the options, such as “register after each image is captured,” “register periodically,” or any other options may be provided.

An apply signature module 308 may be configured to apply digital signatures to images. The module may be configured to create digital signatures or receive digital signatures from the registry and apply the digital signatures to the images. The digital signatures may be the same for every image of a user, be partially the same, or be different for each image. The digital signatures may be created in a variety of ways, such as those described above. In applying digital signatures, the module 308 may be configured to store digital signatures in association with images. In one embodiment, the digital signatures may be stored in metadata of the image. Alternatively, the digital signatures may be applied and embedded in the digital image. Any form of integrating or associating the digital signatures with the digital images may be utilized in accordance with the principles of the present invention.

A register image module 310 may be configured to register images. In registering the images, the module 310 may be configured to use the preferences collected by the preferences module 306. The module 310 may be configured to initiate communicating the images to the registry automatically, semi-automatically, or manually. In response to communicating the images, the module 310 may be configured to receive an acknowledgement, digital signature, portion of digital signature, or other information associated with registering images. The module may be configured to register images captured by the device of the user, and not register images that are received from devices of another user and communicated (e.g., messaged) or otherwise transferred to the device of the user.

A manage/display registered images module 312 may be configured to display the registered images. In one embodiment, the registration may include associating a registration symbol in association with the image. The module 312 may display images that are not registered, as well, but identify images that have been registered with a registration symbol or indicia, which may or may not be different from the digital signature. In managing the images, the module may further be configured to automatically determine whether the user has altered the image, such as edited the image, and automatically re-register or prompt the user as to whether to re-register a new image or replace the originally registered image.

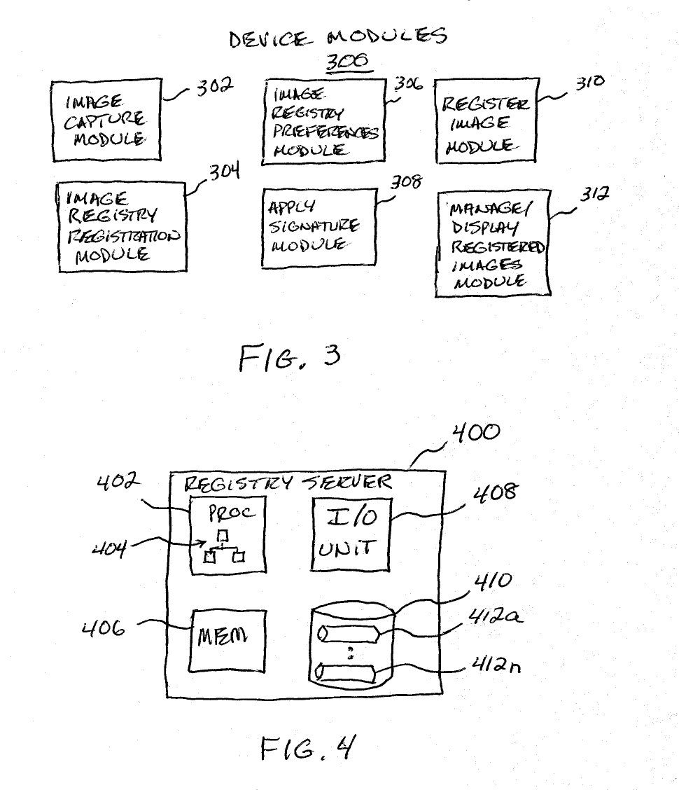

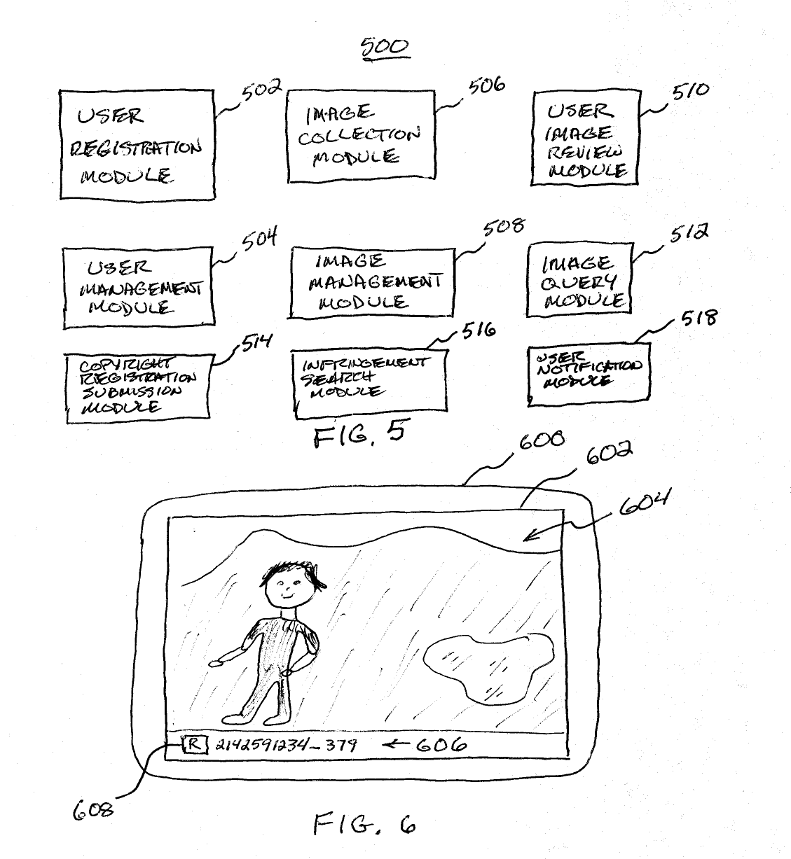

With regard to FIG. 4, a block diagram of an illustrative registry server 400 configured to collect digital images from electronic devices of users, and store and manage the digital images that are registered in the registry is shown. The registry server 400 may include a processing unit 402 that executes software 404 for managing registry functionality, as further described with regard to FIG. 5. The processing unit 402 may be in communication with memory 406, I/O unit 408, and storage unit 410. The storage unit 410 may be configured to store data repositories 412a-412n (collectively 412), which may be configured to store images, registrations, and other information associated with the users and images. The registry server 400 may be formed of one or more servers and include one or more processors that form the processing unit 402. As understood in the art, the server 400 may operate on a communications network, such as the Internet, and be capable of communicating using one or more communications protocols.

With regard to FIG. 5, a block diagram of illustrative software modules 500 that may be executed by the registry server of FIG. 4 for enabling a registry to manage registered digital images is shown. The modules 500 may include a user registration module 502 that may enable a user to register with the registry. The module 502 may prompt the user for name, address, phone number(s), device information (e.g., makes and models of devices), preferences for registering images, preferences for managing images, digital signature, desired storage space (if storage space is fee-based), password, security code(s), authorized users, monitoring services, and any other registration information that may help the registry and user track, manage, and protect images for the user.

A user management module 504 may be configured to enable the registry manage users who are participants of the registry. The module 504 may provide for standard user management of users in a data repository, as understood in the art, and may also provide for the registry to manage the registration process of users. For example, the module 504 may enable the registry to monitor image registration flow from each user and provide notifications to the users if their registration volume is relatively light or excessively heavy.

An image collection module 506 may be configured to manage collection of images from users. The module 506 may be configured to receive images that are being “pushed” to the registry, request images from device(s) of the user in a “pull” manner, such as periodically or event driven (e.g., responding to requests from a user), or other configuration that causes images to be communicated to the registry. The module 506 may further be configured to store images that are received from users in association with the user based on user information (e.g., device ID) that may be collected by the user registration module 502.

An image management module 508 may be configured to manage images associated with each of the users. The module 508, for example, may be configured to tag and track each image associated with a user. The tagging may include applying a digital signature, if not done so by the device that created the image, add additional information to the digital signature, create metadata, apply a timestamp to the image, or otherwise. Alternatively, the image collection module 506 may be configured to apply a timestamp to the image. In one embodiment, access timestamps and information may be associated with the image in the event that the user or someone else accesses the image, such as in the case of the registry making available the images for commercial purposes through instructions of the associated user. Alternative management functions may be performed by the module 508.

The image management module 508 may further be configured to register the image(s) of a user with a copyright office, such as the U.S. Copyright Office. The information collected from the user by the user registration module 502 may be used to auto-populate a form for electronically submitting the image(s) to the copyright office. In one embodiment, fees to be paid to the copyright office in which the image(s) are submitted along with transaction fees for the registry to perform that submission service may be applied to the user's account with the registry, as initiated by the module 508. If the user has requested submission of image(s) to a copyright office, the copyright office for the submission may be one in the country of residence of the user. Moreover, the module 508 may be configured to perform the copyright office registration within a predetermined time period (e.g., 3 months) that meets the requirements by the respective copyright office to allow the user to collect statutory damages based on the laws in the respective country.

A user image review module 510 may be configured to enable a user to review images that have been registered with the registry. The review may enable the user to view the images in a variety of different formats and sizes, as understood in the art. The module 510 may also enable the user to delete, modify, add, or perform other functions to the images that are registered. A “raw” image as registered may be maintained for verification purposes. In one embodiment, information associated with the images, such as timestamps, geographic locations, access information, violations, names of people in the images, and other metadata may be presented to the user when reviewing. Such metadata may be searchable and enable a user to sort images based thereon.

An image query module 512 may be configured to enable a user to query the registry for a particular image. The module 512 may provide a user interface that allows for the user to submit alphanumeric information associated with the user, image, geographic location at which the image was created, geographic location at which the image was submitted to the registry, date range of when the image or images were created, registered, or otherwise, and any other metadata supported by the registry. In one embodiment, the module 512 may be configured to enable a user to submit or select a previously submitted image and the module 512, and may search or cause a search to be conduced to match the image to an image registered by other users as well as perform larger searches on other networks, such as the Internet, or other data repositories. As an example, the user may request that images that are similar to the overall image to be searched. As another example, the user may request that a portion of the image (e.g., face of a person in the image) be searched. Pattern, facial, and/or other image processing and matching techniques as understood in the art may be utilized in accordance with the principles of the present invention. Still yet, the module may be configured to search for images that were created with the same or similar timestamp and/or geographic location as a particular image. The module 512 may be configured to be utilized for free, for a fee, in part for free and in part for a fee (e.g., free search, but pay for “hits”), advertiser or sponsor supported, and otherwise. The search may also include searching for a visible or an embedded digital signature in the image (e.g., in metadata associated with the image or otherwise “hidden” in the digital image).

In one embodiment, the user may request via the module 512 that some or all his or her registered images be reviewed for unauthorized uses by other registrants and on other networks, such as the Internet, periodicals (e.g., online publications or advertisements), an so forth. In another embodiment, the module 512 may be configured by the registry or established as a preference, for free or otherwise, to routinely search for unauthorized uses of image(s). In one embodiment, the module 512 may be configured to compare digital signatures of an image with other images identified and compare network addresses of those other images to determine whether the use of the image at that network address is authorized. Again, the search may be performed to search for the image or a portion of the image, metadata (e.g., name of image, registration indicia), a digital signature associated with the image, or otherwise.

A copyright registration submission module 514 may be configured to enable a user to instruct the registry or computing system in communication with the registry to generate and submit a copyright application. In one embodiment, the request may be via a customer preference user interface that allows the user to instruct the copyright registration submission module 514 or another module in communication therewith to submit a copyright registration request with a copyright office for all images generated by the user on an electronic device (e.g., smart phone), a portion of the images generated by the user (e.g., all images that include an image inclusive of the face of the user), prompt to the user as to whether to submit for a copyright registration after creation of an image or at periodic or non-periodic time intervals, or otherwise. In generating a copyright application, the module 514 may automatically populate a copyright registration form for images, where the auto-population may include entering a title for an image (e.g., “image produced by Tom Jones”), name and address of the user, date of creation of the image, date of first publication of the image (e.g., first time the image is communicated from the electronic device), and so forth. The user may select which copyright office to submit the copyright application. Generally, the selected copyright office is a copyright office that has jurisdiction of a country in which the user resides. The module 514 may further be configured to cause the user to be billed for the submission (e.g., filing fees plus a processing fee). In response to filing, the module 514 may interact with a docket module (not shown) configured to manage a docket of copyright applications filed by the user, and notify the user of status of the copyright applications or registered copyrights.

An infringement search module 516 may be configured to determine whether an image stored in the registry is being infringed. The module 516 may be used to search within the registry and outside the registry (e.g., on the Internet). The module 516 may be configured to search for all or a portion of an image to determine whether an infringement is occurring. In one embodiment, the module 516 may utilize metadata associated with the image, date of creation of the image, geographic location of creation of the image, or any other non-image information associated with the image to assist in matching an unauthorized use of the image or identify an image that could potentially be an image. The module 516 may utilize facial recognition and/or pattern recognition software to identify people, items, locations, or otherwise in an image to match with an image. The module 516 may be executed on a periodic or aperiodic time period based on a user preference or selection (see, for example, soft-button 808 on FIG. 8). In one embodiment, the module 516 may be disabled and be activated upon a user request. The module 516 may generate a report that may be viewed by a user. The infringement search performed by the module 516 may be free, cost a fee, or be a hybrid of free and cost a fee (e.g., free search but pay for search results if any potential infringements exist). Responsive to the search results, the user may be able to select which uses are unauthorized and which are authorized. The authorized uses of an image may be those posted by friends even though technically unauthorized, whereas the unauthorized uses of an image may be posted or distributed for commercial value (e.g., sold and displayed on a website of an entertainment periodical).

A user notification module 518 may be configured to notify a user of a potential infringement of an image. The module 518 may send an alert message or any other electronic message (e.g., report listing websites, periodicals, etc.) to a user in the event of a potential infringement being determined. The module 518 may be configured to receive a response from the user who may indicate whether each potential infringement is authorized or unauthorized. The module 518 may feedback the user responses and add those responses to the registry for future follow-up. Additionally, the module 518 may be configured to send notification to a potential infringer of the potential infringement. The notification may be in any form, such as email, text message, paper mail, or otherwise if an address can be automatically or manually identified of the potential infringer.

The principles of the present invention further provide for creating networks of authors based on common faces in images. The use of facial recognition software may allow for a matrix of relationships of authors to be created so that 1st, 2nd, 3rd, and so on levels of being removed from knowing other authors based on the system identifying an individual and that individual being in images of others and with other people in images of different authors. As a result, an author relationship matrix may be created and made available to authors. Various business models may be utilized for authors to access this matrix that relates them to others. In one embodiment, an author may restrict their images from being used in creation of a matrix or being named or otherwise identified in the matrix.

With regard to FIG. 6, an illustration of an illustrative electronic device 600 including an electronic display 602 that is displaying a digital image 604 that has been registered with a registry is shown. The image 604 is shown to have content, digital signature 606, and a registration indicia 608, thereby notifying the user that the image 604 has been registered. The digital signature 606 may be a telephone number of the device 600 along with an image counter (e.g., 379) of the number of images that have been created by the device 600. As previously described, a wide range of digital signatures may be created and applied to the image. The registration indicia 608 may be any indicia that can alert the user of the fact that the image 604 is registered. In one embodiment, the user may select (e.g., tap) the registration indicia 608 to cause the device 600 to launch to view the registration information that is being stored locally and/or remotely by the registry. In one embodiment, an app or user interface (e.g., HTML5 user interface) through which the user may view images on the device 600 may enable the user to selectively register one or more images.

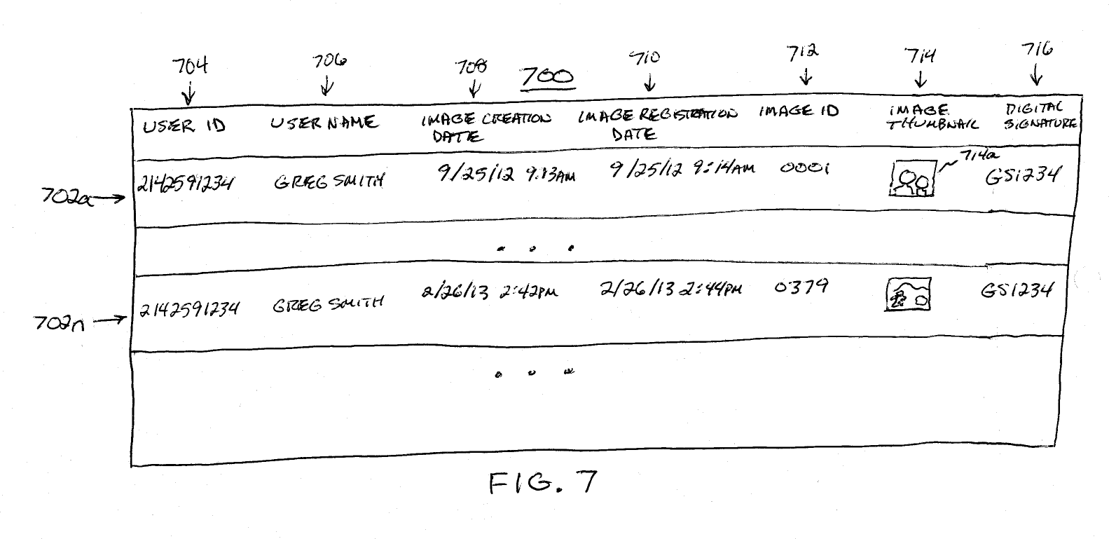

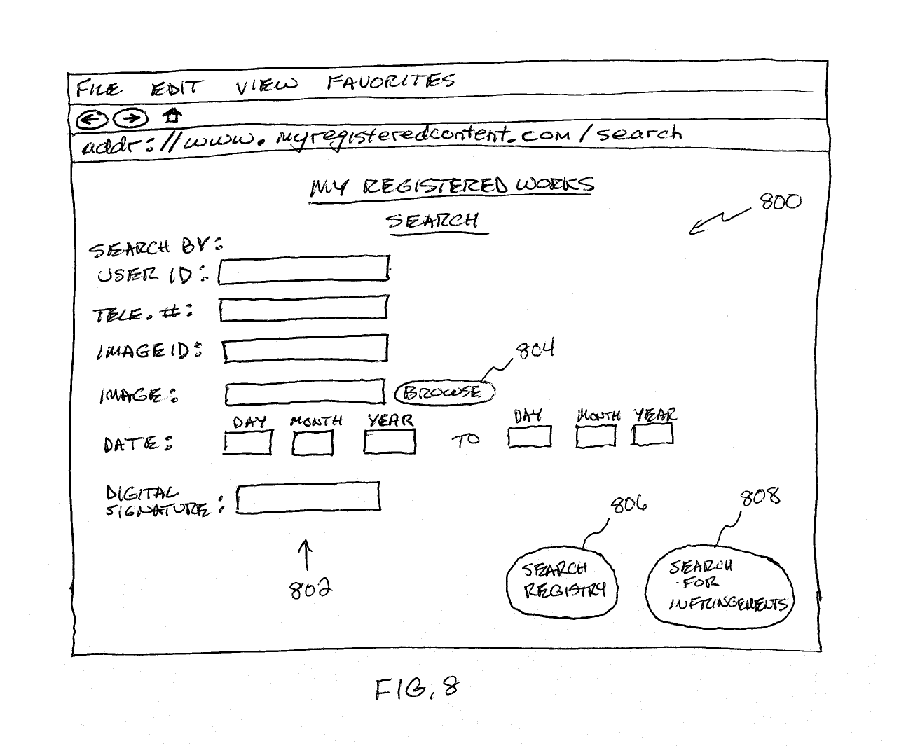

With regard to FIG. 7, a screen shot of an illustrative user interface 700 that provides for display of a record list 702a-702n (collectively 702) of registered digital images is shown. The list may include user ID 704, user name 706, image creation date (timestamp) 708, image registration date 710, image ID 712, image thumbnail 714, and digital signature 716. The image thumbnail 714 may enable a user to view a thumbnail, as understood in the art, of a larger image. In one embodiment, the user may select one record from the records list 702 and be provided with additional information, including the image itself in a larger format (optionally with full resolution). The user may select a thumbnail image 714a to view the image in a larger format and/or full resolution. Additional information may also include copyright registration numbers and other information (e.g., date of filing and registration) associated with each of the images that have been filed and/or registered with a copyright office.

With regard to FIG. 8, a screen shot of an illustrative user interface 800 in which a user may search for registered digital images is shown. The user interface 800 may include a number of illustrative input fields 802 that the user may submit information to search for one or more images. In one embodiment, a “browse” soft-button 804 may enable the user to browse for an image on a device or on the registry to locate an image for which the user desires to search on the registry by selecting a “search registry” soft-button 806 or on a network, such as the Internet, for unauthorized uses of the image by selecting a “search for infringements” soft-button 808, as previously described. It should be understood that the user interface 800 is illustrative and that additional and/or alternative input fields to narrow search parameters may be utilized in accordance with the principles of the present invention.

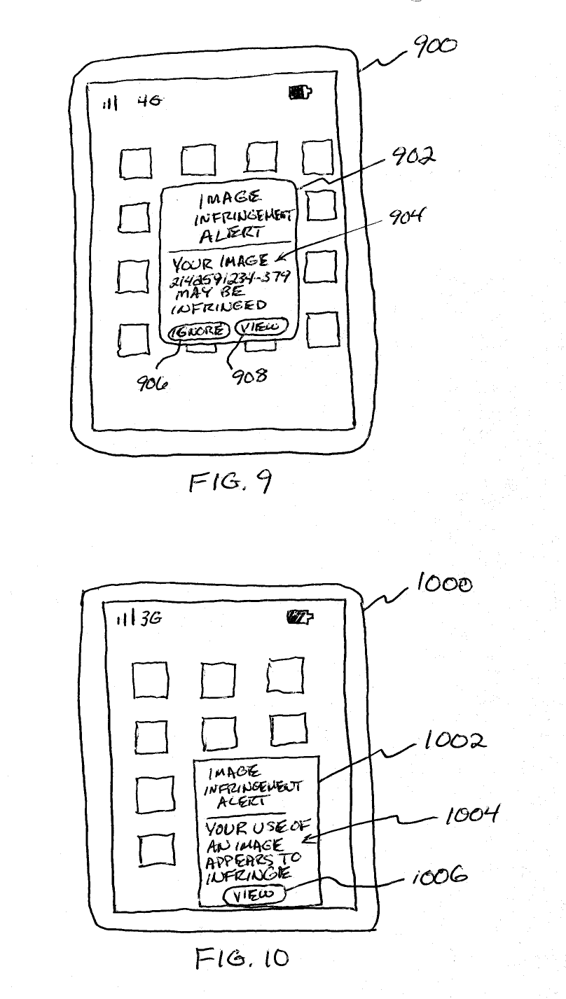

With regard to FIG. 9, a screen shot on an illustrative device 900 of an illustrative message 902 communicated to a user in response to the registry identifying that rights of the user are suspected of being violated by another user using the registered digital image without permission are shown. The message 902 may include a statement 904 inclusive of a particular registered image 904 that is suspected of being infringed. In one embodiment, the message 902 may include an “ignore” soft-button 906 and “view” soft-button 908. Such a message 902 may be communicated to the user in response to the user permitting such push notifications to the user and requesting infringement searches to be performed by the registry.

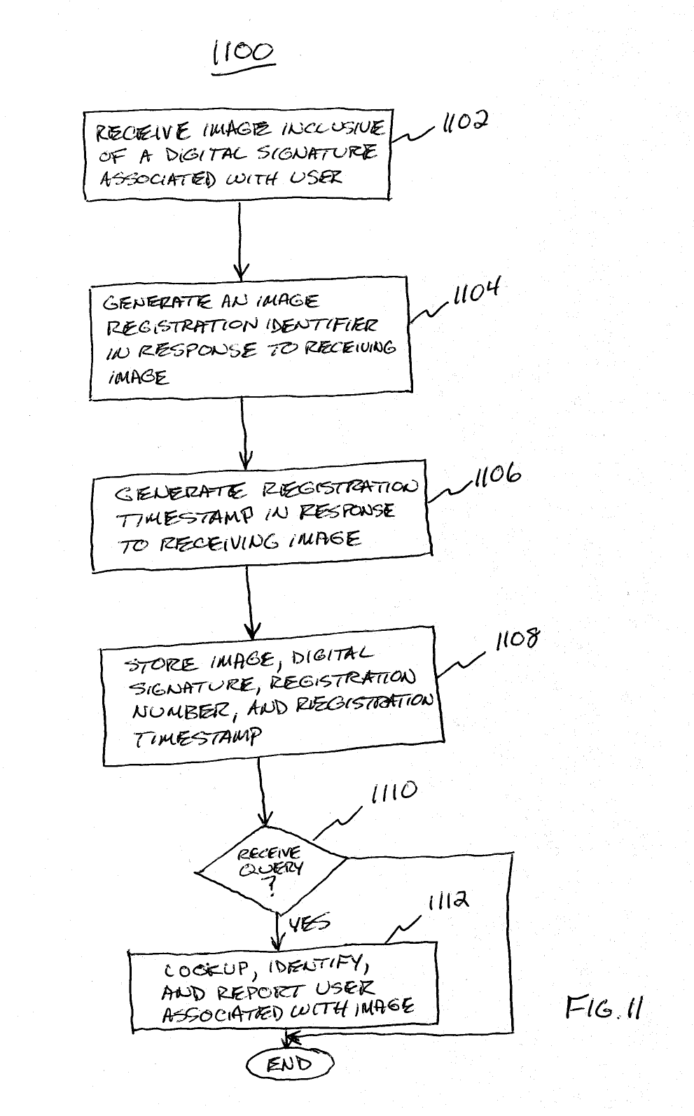

With regard to FIG. 10, a screen shot on an electronic device 1000 of an illustrative message 1002 communicated to a user suspected of violating rights of another user through unauthorized use of a registered digital image is shown. The message 1002 may include a statement 1004 that indicates that the user's use of an image appears to infringe the rights of an author. The message 1002 may include an “view” soft-button 1006 that forces the user to view the image itself and information about the image. In one embodiment, a user interface of the registry may enable the user to submit a response to the “accusation” of the infringement to show why the user believes use of the image is not an infringement. It should be understood that the message 1002 is illustrative and physical letters, electronic messages, or other messages may be generated and communicated to the infringer. Since infringements may be performed on websites knowingly or unknowingly, messages to the host or operator of the website may be communicated, as well.

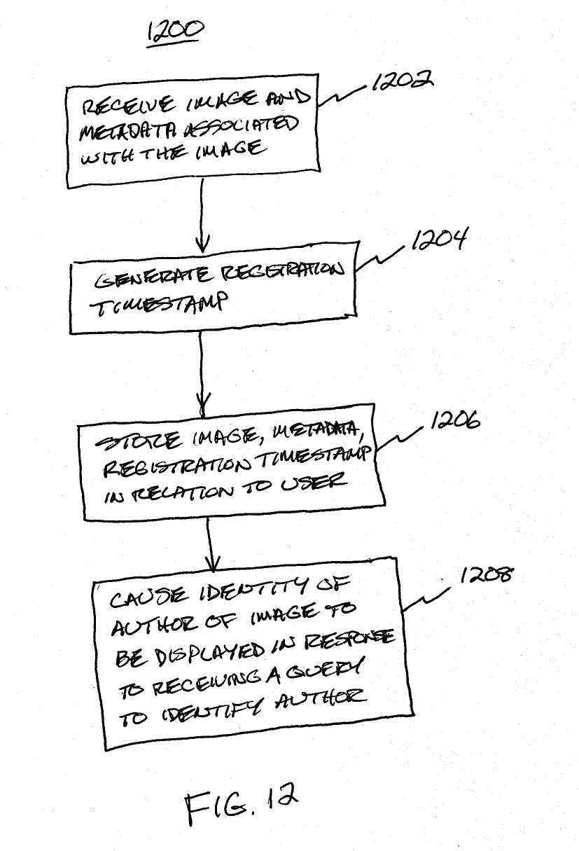

With regard to FIG. 11, a flow chart of an illustrative process 1100 for registering authorship of an image in accordance with the principles of the present invention is shown. The process 1100 may start at step 1102 at which a server receives an image from an electronic device of a user via a communications network. The image may be inclusive of a digital signature associated with the user. An image registration identifier may be generated in response to receiving the image at step 1104. At step 1106, a registration timestamp may be generated in response to receiving the image. The image, digital signature, registration number, registration timestamp, or any other metadata may be stored at step 1108 in relation to the user. In one embodiment, at step 1110, a query for an image may be received. The query may come from the user or another person, such as an investigator or operator at the registry. Alternatively, the query may be initiated automatically pursuant to a preference configuration of the user, for example. In response to receiving a query of the image at step 1110, the user associated with the image may be looked up, identified, and reported.

With regard to FIG. 12, a flow diagram of illustrative process 1200 for managing an image registry is shown. The process 1200 may start at step 1202, where an image and metadata associated with the image to be associated with a user may be received. The user may be an author of the image to be stored in the image registry. In one embodiment, a process being executed by an electronic device may designate an image created by the electronic device to be authored by the electronic device/user. In the event that the user of the electronic device receives an image via a communication, then the user is designated not to be an author of that image. At step 1204, a registration timestamp may be generated in response to receiving the image. At step 1206, the image, metadata, and registration timestamp may be stored in relation to the user. In being in relation to the user, the image, metadata, and registration timestamp may be stored in relation to a user profile, user account, or other information being stored in the image registration that may provide an identity of the user. The identity may be the actual identity of the user or a pseudonym associated with the user. At step 1208, and identity of the author of the image may be caused to be displayed in response to receiving a query to identify the author of an image. The query may be in the form of a search request or otherwise.

The principles of the present invention may be integrated into existing systems. For example, existing social networking sites, such as Facebook®, Snapchat®, YouTube®, or any other image or user generated content platform may integrate the principles of the present invention into an existing platform as an add-on or full integration. Moreover, the principles of the present invention may be integrated into an electronic device, such as a mobile device (e.g., smartphone) as OEM or downloadable app, as understood in the art.

The process 1200 may further be configured to look up the user associated with the image, identify the user associated with the image, look up a current owner of the image, and cause the current owner of the image to be displayed. In one embodiment, a query image may be received, and at least a subset of the query image data may be compared to images in the image registry determine whether the image is registered. A query digital signature associated with the user may be received, and the query digital signature may be compared with digital signatures stored in the image registry. A stored digital signature that matches the query digital signature may be identified.

Moreover, responsive to a preference or request by the author, a copyright application may be automatically generated and populated with information associated with the image. The populated copyright application may be automatically filed with a copyright office. A registration identifier may be generated in response to the image being submitted to the image registry. The image registration identifier may be communicated to the electronic device of the user via the communications network. In one embodiment, the image may be received image from a mobile electronic device configured to capture images and communicate the images via the communications network.

Still yet, the process 1200 may include enabling a user to establish registration preferences for images, where the registration preferences may include an option to prompt the user to register images with the image registry. In response to receiving user identification information, an image registration account may be created for the user at the image registry. The process may automatically search a network, such as the Internet, for potential infringing images of the image, and in response to identifying a potential infringing image, a message may be communicated to the user indicating that a potential infringement has been identified. Additionally, a message may be communicated to the potential infringer indicating the potential infringement.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed is:

1. A method of managing an image registry, said method comprising:
receiving, by a server from an electronic device of a user via a communications network, an image and metadata associated with the image to be associated with the user, the user being an author of the image to be stored in the image registry;
generating, by the server, a registration timestamp in response to receiving the image;
storing, by the server, the image, metadata, and registration timestamp in relation to the user; and
causing, by the server, an identity of the author of the image to be displayed for the user in response to receiving a query to identify the author of the image, the query being inclusive of at least a portion of the metadata or image.

2. The method according to claim 1, further comprising:
in response to receiving a query to identify the author of the image:
looking up, by the server, the user associated with the image;
identifying, by the server, the user associated with the image;
looking up, by the server, a current owner of the image; and
causing, by the server, the current owner of the image to be displayed.

3. The method according to claim 2, wherein receiving the query includes receiving a query image, and further comprising comparing at least a subset of the query image data to images in the image registry determine that the image is registered.

4. The method according to claim 3, wherein receiving the query image includes receiving a query digital signature associated with the user, and further comprising:
comparing the query digital signature with digital signatures stored in the image registry; and
identifying a stored digital signature that matches the query digital signature.

5. The method according to claim 1, further comprising, responsive to a preference or request by the author:
automatically generating, by the server, a copyright application populated with information associated with the image; and
automatically filing the populated copyright application with a copyright office.

6. The method according to claim 1, further comprising:
generating, by the server, a registration identifier in response to the image being submitted to the image registry; and
communicating, by the server, the image registration identifier to the electronic device of the user via the communications network.

7. The method according to claim 1, wherein receiving the image includes receiving the image from a mobile electronic device configured to capture images and communicate the images via the communications network.

8. The method according to claim 1, further comprising:
enabling a user to establish registration preferences for images, the registration preferences including an option to prompt the user to register images with the image registry; and
in response to receiving user identification information, creating an image registration account for the user at the image registry.

9. The method according to claim 1, further comprising:
automatically searching, by the server, a network for potential infringing images of the image; and
in response to identifying a potential infringing image, communicating, by the server, a message to the user indicating that a potential infringement has been identified.

10. The method according to claim 1, further comprising:
automatically searching, by the server, a network for potential infringing images of the image; and
in response to identifying a potential infringing image, communicating a message to the potential infringer indicating the potential infringement.

11. A system for managing an image registry, said method comprising:
a storage unit configured to store the image registry; and
a processing unit in communication with said storage unit, and configured to:
receive an image and metadata associated with the image to be associated with the user, the user being an author of the image stored in the image registry;
generate a registration timestamp in response to receiving the image;
store the image, metadata, and registration timestamp in relation to the user; and
cause an identity of the author of the image be displayed for the user in response to receiving a query to identify the author of the image, the query being inclusive of at least a portion of the metadata or image.

12. The system according to claim 11, wherein said processing unit is further configured to:
in response to receiving a query to identify the author of the image:
look up the user associated with the image;
identify the user associated with the image;
look up a current owner of the image; and
cause the current owner of the image to be displayed.

13. The system according to claim 12, wherein said processing unit, in receiving the query, is further configured to receive a query image, and wherein said processing unit is further configured to compare at least a subset of the query image data to images in the image registry determine that the image is registered.

14. The system according to claim 13, wherein said processing unit, in receiving the query image, is further configured to receive a query digital signature associated with the user, and wherein said processing unit is further configured to:
compare the query digital signature with digital signatures stored in the image registry; and
identify a stored digital signature that matches the query digital signature.

15. The system according to claim 11, wherein said processing unit is further configured to, responsive to a preference or request by the author:
automatically generate a copyright application populated with information associated with the image; and
automatically file the populated copyright application with a copyright office.

16. The system according to claim 11, wherein said processing unit is further configured to:
generate a registration identifier in response to the image being submitted to the image registry; and
communicate the image registration identifier to the electronic device of the user via the communications network.

17. The system according to claim 11, wherein said processing unit, in receiving the image, is further configured to receive the image from a mobile electronic device configured to capture images and communicate the images via the communications network.

18. The system according to claim 11, wherein said processing unit is further configured to:
enable a user to establish registration preferences for images, the registration preferences including an option to prompt the user to register images with the image registry; and
in response to receiving user identification information, create an image registration account for the user at the image registry.

19. The system according to claim 11, wherein said processing unit is further configured to:
automatically search a network for potential infringing images of the image; and
in response to identifying a potential infringing image, communicate a message to the user indicating that a potential infringement has been identified.

20. The system according to claim 11, wherein said processing unit is further configured to:
automatically search a network for potential infringing images of the image; and
in response to identifying a potential infringing image, communicate a message to the potential infringer indicating the potential infringement.
